(19) United States
(12) Patent Application Publication
(10) Pub. No.: US 2011/0104648 A1
(43) Pub. Date: May 5, 2011

(54) SYSTEMS AND METHODS FOR HEALTH BEHAVIOR REINFORCEMENT

(75) Inventors: Michael S. Singer, Newton, MA (US); Murat V. Kalayoglu, Boston, MA (US); John P. Sheehan, Cohasset, MA (US)

(73) Assignee: Healthhonors Corporation

(21) Appl. No.: 12/860,438

(22) Filed: Aug. 20, 2010

Related U.S. Application Data
(60) Provisional application No. 61/236,045, filed on Aug. 21, 2009.

(51) Int. Cl. G09B 19/00

(52) U.S. Cl. 434/236

(57) ABSTRACT

The invention relates to simple yet effective methods, referred to herein as Dynamic Intermittent Reward (DIR), and systems, to increase the frequency of desired behavior(s) in a user, decrease the frequency of an undesired behavior(s), and optimize cost-effectiveness of a reward system. A principal benefit of the new methods is the ability to provide tailored intermittent rewards for one or more users over time for both desired and undesired behaviors.

### CROSS-REFERENCE TO RELATED APPLICATIONS

The present application claims priority to U.S. Provisional Application No. 61/236,045, entitled Systems and Methods for Health Behavior Reinforcement, filed Aug. 21, 2009, the contents of which are incorporated by reference herein in their entirety.

### TECHNICAL FIELD

This invention relates to computer-implemented methods and systems of behavior reinforcement to increase the frequency of health behaviors and reduce the frequency of unhealthy behaviors.

### BACKGROUND

Behavior reinforcement is the formal term for a process that uses positive reinforcement (reward) to increase the frequency of a desired behavior and/or aversive conditioning (penalty) to reduce the frequency of an undesired behavior. As widely appreciated by patients and health care providers, health care and wellness efforts typically involve desired behaviors, which are expected to promote health, and undesired behaviors, which are expected to undermine it. Consider the following non-limiting examples:
For weight loss, desired behaviors may include regular exercise, completing a daily meal diary, and consuming sufficient fluids, fruits, vegetables, and dietary fiber. Undesired behaviors may include eating excessive calories, fats, or certain carbohydrates.
For smoking cessation, desired behaviors may include using nicotine replacement, using appropriate prescription medication, and attending group therapy sessions. Undesired behaviors include smoking and using smokeless tobacco products.
For Type 2 diabetes, desired behaviors may include eating a healthy diet, exercising, losing weight, monitoring blood sugar, taking medications as prescribed, attending medical appointments, and attending regular eye exams. An undesired behavior may be eating sugary foods.
For moderate or severe asthma, desired behaviors may include appropriate adherence to an inhaled corticosteroid and/or oral medications, use of a “spacer” inhalation chamber, and regular measurement of peak expiratory flow. Undesired behaviors may include intentional exposure to triggers (e.g., animal dander, dust, mold) and overuse of short-acting beta-agonists.

Important parameters in behavior reinforcement are the schedule and immediacy of reinforcement. It is important to draw the distinction between a continuous schedule, whereby every instance of a behavior is reinforced, and an intermittent reinforcement schedule, whereby reinforcement occurs only with some instances of a particular behavior. A specific type of intermittent schedule is the variable-ratio schedule, in which reinforcement frequency fluctuates. Likewise, the magnitude of reinforcement can vary, even if reinforcement frequency is continuous or fixed. Variable-ratio schedules tend to motivate people more than if the same amount of reinforcement were distributed on a continuous schedule. This is partly because variable-ratio intermittent reinforcement leads to emotions of anticipation, suspense, and uncertainty. It appears to involve key emotional centers in the brain. The immediacy of the reinforcement, i.e., the delay between the behavior and the reinforcement, is ideal if kept to a minimum. The variable-ratio schedule is to be contrasted with a fixed-ratio intermittent schedule, for example, a predictable reward every third time a desired behavior is performed.

Intermittent reinforcement is particularly effective for behaviors for which repeated performance is desired. For example, in contrast to other methods, intermittent reward tends to elicit more intense and durable behavioral responses than continuous reward. With conventional methods of intermittent reinforcement, however, a limitation is that the value and frequency of reinforcement are not tailored to each user, do not vary in response to user behavior over time, and do not provide automated methods for improving cost effectiveness. For the purpose of positive reinforcement, these problems can be addressed by DIR (herein alternatively referred to as “Dynamic Intermittent Reinforcement”) systems and methods described in PCT Application Serial No. PCT/US2008/050896, which is incorporated herein by reference in its entirety. However, some fields, particularly health care and disease management, involve both desired and undesired behaviors, and would be ideally served by methods and systems to administer both positive and aversive conditioning, potentially simultaneously, for two or more behaviors.

### SUMMARY

The invention relates to simple yet effective computer-implemented methods and systems, referred to herein as Dynamic Intermittent Reinforcement (DIR), to increase the frequency of desired behavior(s) and reduce the frequency of undesired behavior(s) by a user, and further to optimize the cost-effectiveness of a reinforcement system. A principal benefit of the new invention is the ability to provide tailored intermittent reinforcement, as a reward and/or penalty, to one or more users over time. Typically, but not necessarily, reinforcement is denominated in points (or other suitable unit of measure) that users can redeem for things of value.

The new systems and methods are particularly useful for, but not limited to, promoting and/or maintaining health, and/or preventing, managing, monitoring, and/or treating disease or injury [and/or risk factor(s) thereof] in patients with diabetes mellitus, undesired dietary or physical activity characteristics, overweight, eating disorders, asthma, chronic obstructive pulmonary disease (COPD), cystic fibrosis, hypertension, coronary artery disease, other heart disease, gout, HIV or AIDS, hepatitis (e.g., Hepatitis B, C, and/or D), oral disease, inflammatory bowel syndrome, renal insufficiency, autoimmune diseases, arthritis, osteoporosis, cancer, seizure disorders, Alzheimer's disease, depression, anxiety, schizophrenia, other psychiatric disorders, chronic pain, diabetic retinopathy, age-related macular degeneration, other eye diseases, need for anticoagulation, pregnancy, history of organ transplant (or corneal or other tissue graft), need for rehabilitation, cigarette or other tobacco use, and/or substance abuse. The new systems and methods can also be useful for injury prevention, particularly in the workplace. Common to the management of all these conditions is that each involves a one or more desired and undesired behaviors whose practice or avoidance, respectively, are believed to contribute to health outcomes.

Behaviors that can be positively reinforced with the new systems and methods include without limitation adherence to medication(s), receipt of therapy, receipt of vaccinations; adherence to a diet, physical activity or exercise, use of particular diagnostics or monitoring plans (including using a DIR system and/or contacting an Automated Call Center), use of protective equipment or practices, and attendance at appointments, consultations, or therapy sessions. Behaviors that can be aversively conditioned with the new systems and methods include without limitation, avoidance, or reduction of smoking, alcohol, other substances, certain foods, certain caloric intake, fat intake, sodium intake, allergens, other agents known to exacerbate disease, and overuse or misuse of prescription medications. For the purposes of this disclosure, “behaviors” can also mean any evidence, marker, or outcome of one or more behaviors. These may include, for example, a urine cotinine test for cigarette smoking, a hemoglobin A1C test for blood sugar control, or a body mass index for overweight. It is understood that the evidence, marker, or outcome, although considered as one behavior for the purposes of DIR, may be the result of one or more actual behaviors. It is further understood that the evidence, marker, or outcome may not be entirely under a patient's control, provided that the patient has some means to modify his or her behavior and thereby, modify at least in part the corresponding evidence, marker, or outcome. In some circumstances, the user of DIR may be different from the actual patient. For example, a parent may use a DIR system and receive reinforcement contingent on desired and undesired behaviors in the management of a child's asthma.

In one aspect, the invention includes DIR methods for increasing the frequency of a desired behavior and/or decreasing the frequency of an undesired behavior by a user, e.g., to determine tailored intermittent rewards or penalties for a user whereby the value of each said reward or penalty is modulated. The methods comprise (for each desired or undesired behavior): obtaining and/or maintaining a behavior history for the user; calculating a Favorable Behavior Rate (“FBR”) from the behavior history; determining whether reinforcement should be provided; if reinforcement is to be provided, determining a Reinforcement Value, wherein the value of reinforcement is inversely correlated with the FBR; if the behavior is a desired behavior, applying the reinforcement as a reward (credit); if the behavior is an undesired behavior, applying the reinforcement as a penalty (e.g., debit or delay in crediting a reward); and providing the user with a reinforcement report indicating whether a reward or penalty is to be applied and if so, the value thereof. More than one behavior can be reinforced (i.e., rewarded or penalized) on one occasion, and a common reward report can communicate multiple rewards, penalties, and/or the sum thereof. Typically, an account will kept of the Reinforcement Values, both credits (for rewards) and debits or delay in crediting a reward (for penalties), and the balance will reflect the overall amount of economic reinforcement to be provided to a user and to be available for redemption. Redemption can be for discounts, rebates, cash or other things of value. Means of redemption include, but are not limited to, discounts or rebates on a patient's insurance premium, prescription co-pay, healthcare fees, or fitness center memberships. If desired, an electronically encoded discount card akin to a credit card can be used to facilitate such discounts or rebates.

For example, the methods can be computer-implemented DIR methods for obtaining a desired behavior or discouraging an undesired behavior by a user, and are performed by one or more processors, e.g., via Automated Contact Centers as described herein. These methods include (for each desired or undesired behavior): obtaining and/or maintaining a behavior history for the user; calculating a FBR from the behavior history; determining whether reinforcement should be provided; if reinforcement is to be provided, determining a Reinforcement Value, wherein the value of reinforcement is inversely correlated with the FBR; if the behavior is a desired behavior, applying the reinforcement as a reward (credit); if the behavior is an undesired behavior, applying the reinforcement as a penalty (e.g., debit or delay in crediting a reward); and providing the user with a reinforcement report indicating whether a reward or penalty is to be applied and if so, the value thereof.

In another aspect, the invention features methods for obtaining a desired behavior or discouraging an undesired behavior by a user using DIR, e.g., where reinforcement frequency, rather than value, is modulated. These methods include (for each desired or undesired behavior): obtaining and/or maintaining a behavior history for the user; calculating a FBR from the behavior history; determining whether reinforcement should be provided; if reinforcement is to be provided, determining a Reinforcement Value, wherein the frequency of reinforcement is inversely correlated with the FBR; if the behavior is a desired behavior, applying the reinforcement as a reward (credit); if the behavior is an undesired behavior, applying the reinforcement as a penalty (e.g., debit or delay in crediting a reward); and providing the user with a reinforcement report indicating whether a reward or penalty is to be applied and if so, the value thereof. If desired, both value and frequency can be modulated.

In some embodiments, steps that involve determining whether reinforcement should be provided, determining the Reinforcement Value, and/or applying the reinforcement as a credit or penalty can be combined into a single step, e.g., by use of a static table.

In some embodiments, these methods can further include identifying the user and retrieving the user's behavior history, recording a most recent behavior in the user's behavior history, providing to the user a user identification code, and obtaining the user identification code to identify the user.

In various embodiments, a simple FBR can be calculated as follows: For desired behaviors, by determining a first number of times the user performed the desired behavior over a specified period of time, and dividing the first number of times by a second number of times the user is expected to perform the desired behavior over the period of time. For undesired behaviors, by determining a first number of times the user's behavior was assessed and the user did not perform the undesired behavior over a specified period of time, and dividing the first number of times by a second number of times the user's behavior was assessed over the period of time. Methods to calculate a more sophisticated FBR, which are preferred in some embodiments, are described herein (cf. Adherence Index or AI).

According to DIR methods, the relationship between (i) the value of the reinforcement or the likelihood that reinforcement is provided and (ii) the FBR can be described by a Spearman's rank correlation coefficient of less than zero, e.g., less than −0.5, or the value can be −1. In certain embodiments, the likelihood that reinforcement is provided, or the value of the reinforcement, can be proportional to the difference between (i) the FBR, (ii) and a specified number.

In another aspect, the invention features systems for obtaining a desired behavior or discouraging an undesired behavior by a user using the DIR methods described herein. These systems include an Automated Contact Center having a communications port, a processor, and an electronic apparatus readable medium configured to cause the processor to: identify the user via a communications network; receive a report of user's behavior via the communications network; and carry out any of the DIR methods described herein.

For example, the contact centers can include a communications port, a processor, a memory, and an electronic apparatus readable medium encoded with a program that when executed by the processor cause the processor to carry out the new method(s) described herein.

In these systems, the electronic apparatus readable medium can be further configured to cause the processor to determine whether desired and/or undesired behavior(s) have occurred at an appropriate time and/or to cause the processor to report to the user when a behavior should (or should not) be performed. In certain embodiments, the reward report can include, or is preceded or followed by, an informative or instructive message or a query. The informative or instructive message or query can be selected from among a plurality of messages or queries depending on the behavior history or FBR.

The systems described herein to perform the DIR methods can be used, for example, to increase the frequency of desired behaviors (e.g., physical exercise; a particular diet; weight loss; medication adherence; monitoring of blood glucose, blood pressure, or another such health parameter; attendance at appointments; receiving health education; maintaining a health-related diary or log; obtaining or maintaining a clinically acceptable body mass index, blood pressure, or hemoglobin A1C) and/or undesired behaviors (e.g., smoking; improper or undesired use of alcohol, tobacco, or other substances; eating foods with improper caloric, fat, carbohydrate, or sodium content; weight gain; excessive body mass index, blood pressure, or hemoglobin A1C; overuse or misuse of a medication; failure to carry out a desire behavior).

As used herein, “intermittent reward” is defined as any method of reward wherein the nature, value, and/or frequency of reward differs, or can differ, between two or more occurrences of a specified behavior.

As used herein, “tailored” or “to tailor” is defined as any method of reinforcement wherein the nature, value, and/or frequency of reinforcement is varied for at least two different users in a plurality of users, or is varied over time for the same user.

As used herein, “inversely correlated” or “inverse correlation” is generally defined as any relationship, whether linear, nonlinear, univariate, or multivariate, between variables wherein lower values of one variable tend to be associated with higher values of another variable. In some embodiments, “inversely correlated” is defined as any relationship between two variables wherein the Spearman's rank correlation coefficient is less than 0. In certain embodiments, the Spearman's rank correlation coefficient is statistically significant. Spearman's rank correlation coefficient (sometimes known as Spearman's rho) is a widely used nonparametric method to assess the correlation between two variables; its application is familiar to anyone skilled in the art.

As used herein, a “Behavior History” is defined as any record of particular behavior(s) performed by a user, or not performed by user, or both, over time.

As used herein, “Favorable Behavior Rate,” and its synonymous acronym “FBR” are defined as any numerical expression of: (1) the desired behavior(s) performed by a user over a specified period of time, and/or (2) the undesired behavior(s) not performed over a specified period of time.

As used herein, “to detect [a behavior]” or “detected [a behavior]” is defined as any method or process that determines or infers that a particular behavior has occurred or is likely to have occurred.

As used herein, “to report [a behavior]” or “reported [a behavior]” is defined as any method or process that communicates the occurrence of a particular behavior, whether confirmed or inferred. The communication may be between two persons, between two devices, or between a person and a device.

As used herein, to “apply” reinforcement is defined as (1) any giving or taking, promising to take or give, crediting or debiting, delaying, deferring, inactivating, removing, or postponing points, currency, or thing(s), however denominated, of intrinsic value or redeemable for thing(s) of value, whether real or abstract.

As used herein, “penalty” is defined as taking, debiting, negating, removing, delaying, deferring, or postponing points, currency, or thing(s) of value or redeemable for thing(s) of value; or deferring or postponing the redemption thereof.

As used herein, “user identification code” is defined as any information, e.g., serial number, identification number, social security number, name, address, telephone number, etc., useful for identifying a user.

The DIR systems and methods can be used to administer intermittent reward that is tailored to each individual and responsive to fluctuations in individual behavior over time. DIR has the tendency to optimize the frequency of behavior(s) over time and allows an operator to control the overall cost of rewards.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features, objects, and advantages of the invention will be apparent from the description and drawings, and from the claims.

### DESCRIPTION OF DRAWINGS

FIG. 1 is a schematic representation of a database containing a Behavior History.

FIG. 2 is an example of a series of Behavior Instance records from a Behavior History for cigarette smoking.

FIG. 3 is a table showing an exemplary method of calculating a Favorable

Behavior Rate (“FBR”) based upon a hypothetical Behavior History of a user's cigarette smoking.

FIG. 4 is a flow chart showing an exemplary process for carrying out a DIR method on a DIR system comprising an Automated Contact Center, whereby the method and system apply positive reinforcement for desired behaviors and aversive conditioning for undesired behaviors.

FIG. 5 is an exemplary table (i.e., a so-called “static table”) showing Reinforcement Values (RV) corresponding to particular values of the Favorable Behavior Rate (FBR).

FIG. 6 is an tabular summary of 6 weeks of behaviors by a hypothetical user of a DIR system. The behaviors comprise: (1) cigarette smoking and (2) contacting a DIR system.

### DETAILED DESCRIPTION

This invention is based on novel approaches to provide intermittent reinforcement to one or more users.

DIR includes systems and methods that tailor intermittent reinforcement in response to a user's behavior. DIR continually updates reinforcement parameters over time as user behavior fluctuates. For rewards, a feature of DIR is that the value or the frequency of reward, or both, tend to be inversely correlated with the frequency of a desired behavior. Generally, the less frequent a desired behavior, the more positive reinforcement is provided for each instance of the desired behavior. This feature, which may at first seem counter-intuitive, actually provides a powerful means to increase the frequency of a desired behavior and simultaneously control overall reward expenditures.

The present disclosure describes methods and systems that extend DIR to reduce the frequency of undesired behaviors. This is accomplished by the new recognition that for any behavior, whether desired or undesired, a Favorable Behavior Rate (“FBR”) can be calculated, whereby the FBR indicates how frequently a desired behavior was performed in a specified period of time or how infrequently an undesired behavior was performed in a specified period of time. Whether a health behavior is desired or undesired, the skilled artisan will recognize that a higher FBR indicates a pattern of behavior that is desirable (i.e., expected to promote health), whereas a lower FBR indicates a pattern of behavior that is expected to undermine health. The use of an FBR (in lieu of the Behavior Adherence Rate described in PCT Application Serial No. PCT/US2008/050896) makes it possible to administer DIR for both desired and undesired behaviors. It is further possible, if desired, to administer DIR for a plurality of such behaviors simultaneously. A particular advantage of this approach is that it exploits the concept of loss aversion, the strong human preference for avoiding a loss as compared to a gain of the same magnitude. For example, if during the first 3 days of a DIR-associated asthma management program a user accumulates 275, 225, and 200 points, respectively, by performing desired behaviors, performance of an undesired behavior on day 4 might, subject to DIR calculations, result in a temporary or permanent forfeiture of 250 points by the user. The notion of loss aversion predicts that the user, making and having made effort to accumulate points, will be strongly motivated to avoid the undesired behavior and point forfeitures in the future.

Desired behaviors that can be positively reinforced with the new systems and methods include without limitation adherence to medication(s), receipt of vaccinations; adherence to a diet, physical activity or exercise, use of particular diagnostics or monitoring plans (including a DIR system itself), and attendance at appointments, consultations, or therapy sessions. Undesired behaviors that can be aversively conditioned with the new systems and methods include without limitation avoidance or reduction of smoking, alcohol, other substances, certain foods, overall caloric intake, fat intake, sodium intake, allergens, other agents known to exacerbate disease, and overuse or misuse of prescription medications. For the purposes of this disclosure, “behaviors” can also include evidence, markers, or outcomes of one or more behaviors. These may include, for example, a cotinine test for cigarette smoking, a hemoglobin A1C test for blood sugar control, or a body mass index for overweight. It is understood that the evidence, marker, or outcome, although considered as one behavior for the purposes of DIR, may be the result of one or more actual behaviors. It is further understood that the evidence, marker, or outcome may not be entirely under a patient's control, provided that the patient has some means to modify his or her behavior and thereby, modify at least in part the corresponding evidence, marker, or outcome. In some circumstances, the user of DIR may be different from the actual patient. For example, a parent may use a DIR system and receive reinforcement contingent on desired and undesired behaviors in the management of a child's asthma.

### Detecting, Reporting, and Recording Behaviors

All embodiments of DIR require detection of a behavior, e.g., using some device or means to detect a behavior. Some embodiments require means to report or record a behavior, or both. Some embodiments require means to identify a user. Before the methods of DIR are described in detail, the means to detect, report, and record behaviors will be reviewed. The means to identify a user will also be reviewed. It should be understood that any means or facility for detecting, communicating, recording, analyzing, handling, or otherwise responding to a desired behavior as described in PCT Application Serial No. PCT/US2008/050896 can generally be used, in the context of the present disclosure, for an undesired behavior.

### Detecting Behaviors

DIR provides reinforcement to a user in response to a desired or undesired behavior. There is therefore a need to detect the desired or undesired behavior.

A desired or undesired behavior can be detected in many ways. For example, a user can report the behavior himself or herself A health care provider (e.g., nurse, physician, therapist), family member, laboratory technician, caretaker, instructor, service provider, or other can observe the behavior.

A desired behavior can also be detected automatically. For example:

1. The obtaining or buying of a product can be detected when a Universal Product Code (UPC) bar code, membership card, or other printed matter or electronic medium is scanned, e.g., at a clinic, pharmacy, or point-of-sale terminal.

2. Computer records can be analyzed. For example, a user's visit to a clinic or website can be detected automatically by a host computer.

3. A wide array of tests, sensors, and devices, familiar to those skilled in their respective arts, can be used to detect or infer the occurrence of a behavior:

(a) scales to detect the weight of a person or material;

(b) monitors of physiologic function, such as heart rate, blood pressure, or oxygen saturation;

(c) laboratory tests;

(c) diagnostic medical devices, such as a blood glucose monitor;

(d) mechanical, optical, magnetic, sonic, or thermal sensors to detect the opening or closing of a door or container, or the location or movement of a person or item;

(e) radio frequency identification (RFID) tags to detect the location or movement of a person or item; and

(f) a global positioning system (GPS) units to detect the location or movement of a person or item.

### Identifying the User

In some embodiments of DIR, there is a need to identify the user, i.e., he or she who performed the behavior. The user may be identified by his or her name, social security number, driver's license number, credit card number, membership number, prescription number, telephone number, address, electronic mail (e-mail) address, username, any other unique serial number, or any other suitable identifying number, code, or information.

### Reporting Behaviors

In some embodiments of DIR, the occurrence of a behavior, once detected, is reported to a remote entity, e.g., a central computer or a contact center, typically using a communications network. Such reporting and communications networks are described in detail in PCT Application Serial No. PCT/US2008/050896.

### Behavior History

In all embodiments of DIR there is a need to record a user's behavior over a specified period of time. These embodiments therefore require a means to obtain or maintain a record, herein called a “Behavior History.”

A Behavior History can be stored in a standard database on a computer, e.g., a central computer. Any database (or even a simple variable array or flat text file) can be used, e.g., Microsoft SQL Server or Microsoft Access. A user's record of behavior is preferably stored as a time-and-date record.

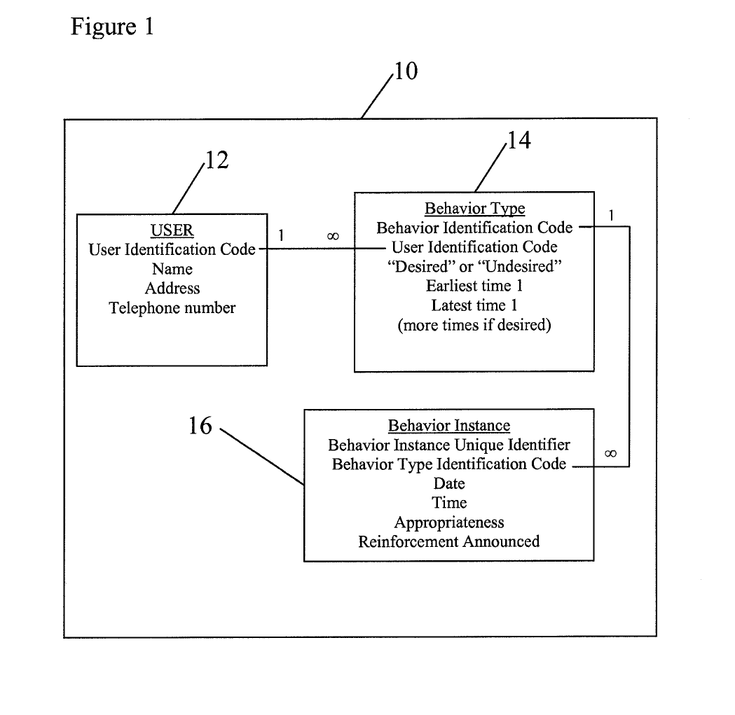

FIG. 1 is a schematic representation of an exemplary Behavior History database 10, which may comprise:

1. A table 12 called “User.” where each user has his or her own record, and whereby each record contains a “User Identification Code” and other desired identifying information.

2. A table 14 called “Behavior Type,” whereby each record contains: a “Behavior Identification Code,” a User Identification Code, an indication of whether the behavior is “desired” or “undesired,” and an expression of the schedule by which the performance or non-performance of the behavior should be assessed. In this example two variables are specified for a behavior to be performed over a set time period, e.g., a year, one or more months, a week, a 24-hour period, or a 12-hour period: the earliest time of day and the latest time of day. For example: “Check peak expiratory flow,” earliest time 3 pm, latest time 11 pm. A twice-yearly appointment could be: “appointment 1,” earliest date October 1, latest date November 30; “appointment 2,” earliest date April 1, latest date May 31. The schedule can be expressed in a variety of other ways obvious to a skilled artisan. A single record in “Individuals” can be related to one or many records in “Behavior Type.” In some embodiments, the actual time when the behavior is performed is not important, as long as the behavior is performed during a specific window of hours, days, weeks or month.

3. A table 16 called “Behavior Instance,” whereby each record corresponds to a single instance that the user has performed the desired behavior. Each record contains a “Behavior Instance Unique Identifier,” a Behavior Identification Code, a date or time or both, the reward provided (if any), and an optional Appropriateness field. The “Appropriateness” field, which can carry values such as “on-time” or “not on-time,” is determined by comparing the time in the “Behavior Instance” record with the earliest and latest times or dates in the related “Behavior Type” record, as would be obvious to anyone skilled in the art. A single record in “Behavior Type” can be related to one or many records in “Behavior Instance.”

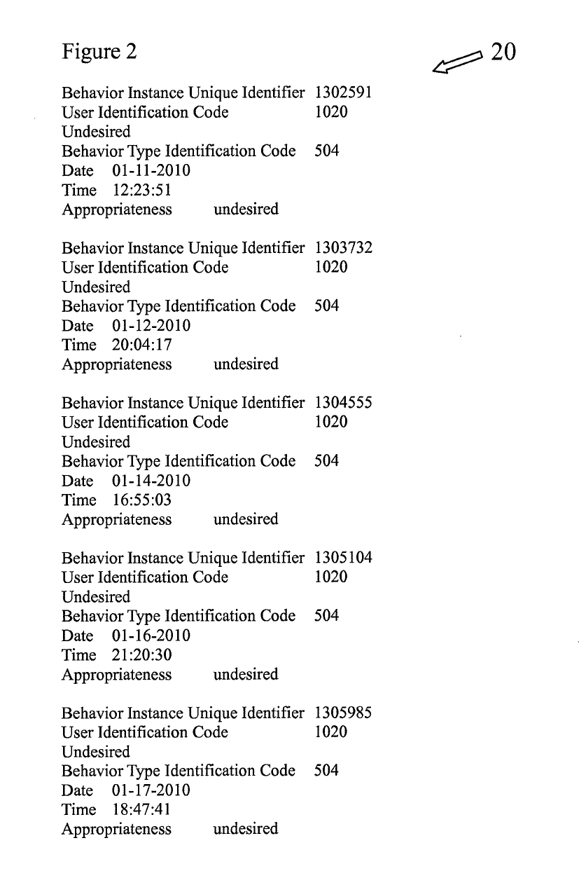

FIG. 2 shows a series of exemplary Behavior Instance Records for a hypothetical patient's smoking behavior.

### Dynamic Intermittent Reinforcement (DIR)

DIR comprises any method of intermittent reinforcement wherein the value of the reinforcement, or the likelihood that a reward will be awarded, is inversely correlated with a user's FBR. The FBR is determined from a Behavior History. This inverse relationship between the FBR and reward value or frequency may at first seem counterintuitive, but it has useful and unexpected properties.

Under DIR there will be a tendency for each person to reach an equilibrium with respect to Reinforcement Value and FBR. Reward values and frequencies can be modulated, even individually, to influence where this equilibrium occurs. A clear benefit of this approach is that an operator can direct most of the funds in a finite pool to those who represent new instances of a desired behavior (or new cessation of an undesired behavior), rather than to those people who would perform the desired behavior (or shun the undesired behavior) even in the absence of a reward. Another novel benefit of the system is that it provides more incentive to those people who demonstrate more need for incentive to modify their behavior patterns. Finally, another useful property is that the system responds rapidly and automatically to a user's fluctuations in behavior in a way that will entice the user to increase the frequency of desired behaviors and reduce the frequency undesired behaviors.

It is helpful to contrast DIR with conventional intermittent reinforcement as well as continuous reinforcement. Conventional methods of intermittent reinforcement (such as a lottery tickets or parking tickets) do not allow different, tailored reward frequencies to help individuals who need relatively more motivation. Continuous reinforcement, on the other hand, involves fixed reinforcement amounts, for example, $1 per dose of medication taken on schedule. To reward individuals sufficiently with either of these approaches is likely to be prohibitively expensive and/or insensitive to the ways in which different people respond to behavior modification. DIR, on the other hand, motivates each user at reasonable costs for the overall system, and continually seeks to reduce the costs in the system.

A detailed method to implement DIR is described herein. The method is conducted each time a user contacts a DIR system and/or is eligible for reinforcement (or it can be conducted ahead of time, with the results stored for later use).

The Favorable Behavior Rate (FBR) is calculated from the Behavior History. A simple, exemplary method of calculating the FBR is as follows: for desired behaviors, by determining a first number of times the user performed the desired behavior over a specified period of time, and dividing the first number of times by a second number of times the user is expected to perform the desired behavior over the period of time; for undesired behaviors, by determining a first number of times the user's behavior was assessed and the user did not perform the undesired behavior over a specified period of time, and dividing the first number of times by a second number of times the user's behavior was assessed over the specified period of time. For example, if the period of time to be evaluated is 30 days, a patient's cigarette smoking (an undesired behavior) was assessed on a twice-daily basis, and the patient was found to have smoked cigarettes during 36 of 60 half-day periods, a simple FBR could be calculated as (60−36)/60=0.4.

Once an FBR has been determined, the next step is to determine a Reinforcement Value (RV) as a function of the FBR. This calculation should tend, on a stochastic basis, to yield an inverse correlation between the FBR and the Reinforcement Value (or reinforcement frequency). For example, the reward value can be calculated as $5 multiplied by (1.0−FBR), or in the present example, $5 (1.0−0.4), or $3.

The next step is to determine whether reinforcement will be applied or not for the particular instance in question. Methods to determine this are disclosed in detail in PCT Application Serial No. PCT/US2008/050896. In a preferred embodiment, Tabular Intermittent Reward (TIR) is used to determine both the Reinforcement Value and whether reinforcement will be applied. If desired, one step may be used to determine both whether reinforcement will be applied and the value thereof (e.g., for a given FBR value, a static table may yield an RV of 0, meaning that no reinforcement will be applied). [In the same step, if desired, the value of reinforcement can also be used to determine whether the reinforcement is to be a reward or penalty, e.g., with a positive RV indicating a reward and a negative RV indicating a penalty].

If reinforcement is to be applied, a necessary step is to determine whether the reinforcement will be applied as reward (i.e., a credit) or a penalty (i.e., a debit or delay in crediting a reward). If the behavior is a desired behavior, the reinforcement is a reward in the amount of the Reinforcement Value. If the behavior is an undesired behavior, the reinforcement is a penalty in the amount of the Reinforcement Value. In the above example of cigarette smoking, a penalty of $3 would therefore be applied. If desired, this step can be performed at an earlier stage in the process.

A “reinforcement report” is then made, i.e., the user or another party is notified of the reinforcement, or the reward is credited automatically; this may optionally make use of a communication network or Automated Contact Center (see PCT Application Serial No. PCT/US2008/050896).

The user can repeat the process at specified intervals, returning to the starting state.

### Further Methods to Calculate a Favorable Behavior Rate (FBR)

As described above, FBR can be calculated by the above simple method for the past week, past month, or any other desired period of time. Note that the FBR, as it applies to the “past week,” will vary with each new day, as the definition of the “past week” is updated in a so-called “moving-window average.” In this case FBR will be a number between 0 and 1 inclusive. Likewise, values of FBR can be calculated for the week before the past week, the week before that, and so on.

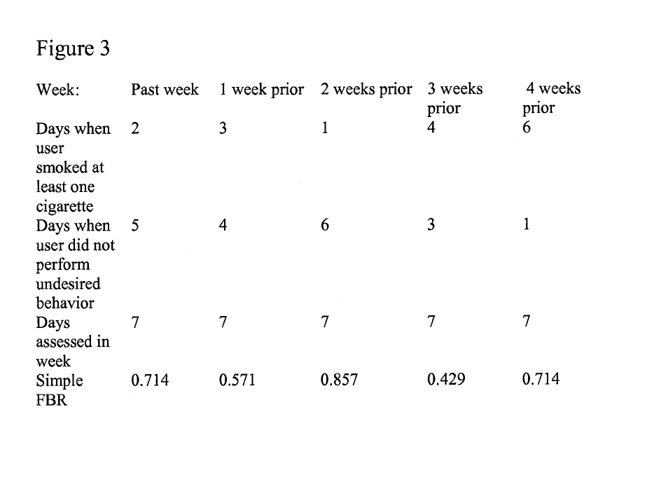

In some embodiments a more sophisticated method of calculating FBR can be used to incorporate records acquired over longer periods of time. If desired, a function can weigh recent behavior more heavily than remote behavior. FIG. 3 is a 5-week summary of relevant information from a hypothetical behavior history. For each week, it can be seen how many days in the week the patient smoked a cigarette (i.e., the undesired behavior). From this it can readily be calculated how many days in each week the patient did not perform the undesired behavior; this value becomes the numerator of the simple FBR. Since in this example the behavior was assessed 7 days a week, the divisor of the simple FBR is 7.

From the simple FBR values shown in FIG. 3, a preferred, alternative method of calculating FBR, herein called the Adherence Index (AI) can be calculated by a geometric series as follows:

AI=simple FBR (past 7 days)/2+simple FBR (1 week prior)/4+simple FBR (2 weeks prior)/8+simple FBR (3 weeks prior)/16+simple FBR (4 weeks prior)/32+1/32=0.714/2+0.571/4+0.857/8+0.429/16+0.714/32+1/32=0.687.

The above term of 1/32 (generally, 1/2̂n where n is the number of terms in the geometric series) is in place to ensure that if all simple FBR values were equal to 1, then the overall sum would equal 1. If sufficient data are available, the series can be expanded to include six or more terms. The Adherence Index (AI) will be a number between 0 and 1 inclusive. A skilled artisan will appreciate that other functions can be substituted for the FBR, with the same essential result of expressing a rate of the user's behavior over time.

### Behavior Modification Systems

As described in PCT Application Serial No. PCT/US2008/050896, behavior modification systems can be used to administer the DIR methods described herein. A user, e.g., a patient, performs a desired or undesired behavior. The behavior is detected, the user is identified, and the behavior and user identity are reported, preferably over a communication network, to a central computer. Each report may convey information about one or more behaviors.

When a behavior is reported or when a user contacts the system, or on a pre-scheduled basis, the central computer employs the methods of DIR, explained elsewhere in this application. The input comprises the user's Behavior History. The input will typically also include information to identify the user. The output is a Reinforcement Report, i.e., whether the user is to receive reinforcement, and if so, the value of the reinforcement and whether it is a reward or a penalty. If implementation of the DIR methods by the central computer so determines, a reward or penalty is applied. A reward can be in the form points, currency, or thing(s), however denominated, of intrinsic value or redeemable for thing(s) of value, whether real or abstract. A penalty can be deduction, loss, or forfeiture of anything comprising a reward.

Reinforcement is preferably applied upon automatic notification by the central computer, e.g., a reward coupon can be sent automatically or communicated to the user or a merchant, or the user's account can be credited (or debited or delayed) electronically. Optionally, this communication can occur over a communication network.

Redemption of rewards can be for discounts, rebates, cash or other things of value, real or abstract. Means of redemption include, but are not limited to, discounts or rebates on a patient's insurance premium, prescription co-pay, healthcare fees, or fitness center memberships. If desired, an electronically encoded discount card akin to a credit card can be used to facilitate such discounts or rebates.

The reinforcement report can also include an informative or instructive message, and this message can vary depending on the FBR and the nature of the behavior, e.g. whether the behavior is desired or undesired. For example, a patient with an excellent history of using hypertension medication may receive a report as follows: “Thank you for continuing to treat your blood pressure.” In contrast, a patient with an unacceptable FBR of smoking may receive a report as follows: “Smoking is increasing your risk of cancer, heart disease, and stroke.” As another example, a user with a FBR of 0.9 or more may hear a recorded message from a celebrity, whereas another user with a Behavior Adherence Rate of less than 0.9 may hear one with a standard voice.

### Automated Contact Centers (ACC)

As described in PCT/US2008/050896, the new behavior modification systems may include one or more control or contact centers, e.g., automated contact centers (ACC) that users or observers can contact via any form of communication network. The ACC is useful for a number of purposes: behavior reports, implementation of DIR, reward reports, and other announcements or content delivered in connection with reward reports.

### EXAMPLES

The following examples are not to be construed as limiting in any fashion.

### Example 1

### DIR to Promote Desired Behaviors and Reduce Undesired Behaviors in Adults with Overweight

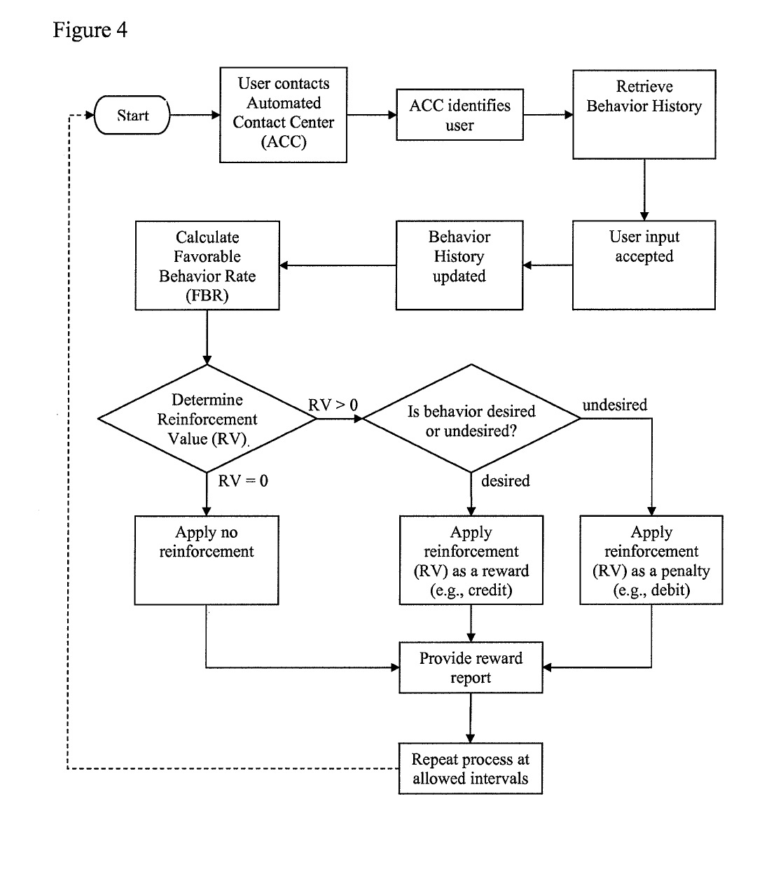

A DIR method is implemented on a DIR system to (1) promote appropriate physical activity and (2) reduce excess calorie and fat consumption in overweight adults. FIG. 4 shows the process flow for this method and system. To promote use of the system, contacting the system daily is itself treated as a desired and reinforced behavior. To determine the reinforcement amount and whether reinforcement is to be applied, the DIR methods also use TIR methods. The system is administered by an Automated Contact Center (ACC), whereby users (i.e., overweight adults enrolled in the program) can contact the ACC by interne, mobile device, or telephone (i.e. interactive voice response). Users are permitted to contact the ACC once daily and enter into the system (and thereby the respective Behavior History) their daily exercise and food consumption, as well as their body weight, if measured [the user's stature is entered at the time of enrollment]. Entry of body weight information allows later statistical comparisons to body mass index (BMI).

Each time the user contacts the system, the respective Behavior Histories for system contact, physical activity, and food intake are updated accordingly. Daily system contact is counted as a desired behavior. Physical activity is counted as a desired behavior if the user performs a minimum of 30 minutes of physical activity with a target heart rate exceeding 60% of maximum. Food intake is counted as an undesired behavior if daily food consumption exceeds 100% of the US Recommended Daily Allowance (RDA) for either calories or fat. For each of these behaviors, respective FBR values are calculated with an Adherence Index (AI) approach (see above) based on the prior five weeks of behavior; static tables are used to determine whether reinforcement should be provided, and if so, the value thereof; and the system determines whether a reward or penalty should be applied based on whether the behavior is desired or undesired, respectively. The system applies the reinforcement accordingly and issues a reinforcement report to the user.

In this example, AI calculations for a user on a particular occasion yield FBR values of 0.905, 0.895, and 0.695, respectively, for system contact (desired), physical activity (desired) and inappropriate food intake (undesired). By reference to separate static tables, these FBR values correspond to Reinforcement Values of 15, 35, and 40 points, respectively. Rewards of 15 and 35 points are therefore applied for system contact and physical activity, but a penalty of 40 points is applied for inappropriate food consumption. A reinforcement report is issued to the user by way of the ACC communicating the reward of 50 points, the penalty of 40 points, and the net gain of 10 points, as well as the user's point balance, which takes into account the users'cumulative awards, penalties, and redemptions (i.e., redemption of points for things of value, such as diabetes-friendly cookbooks and fitness equipment available as part of the DIR program).

### Example 2

### DIR to Promote Desired Behaviors and Reduce Undesired Behaviors in Adults in a Smoking Cessation Program

A DIR method is implemented on a DIR system to reduce cigarette smoking in adults. An incidental benefit of the system is that it maintains a record of self-reported user behavior for review by counselors, therapists, practitioners, etc. The process flow for this method and system is as shown in FIG. 4. To determine the reinforcement amount and whether reinforcement is to be applied, the DIR methods also use TIR methods. The system is administered by an Automated Contact Center (ACC), whereby users (i.e., adults enrolled in a smoking cessation program) contact the ACC through the internet or by mobile device and confirm each day how many cigarettes, if any, they have smoked. Each week the user reviews the data in person with a counselor, and the data are verified with a urine cotinine test. Points collected by the user as part of the program are forfeited if the results of a urine cotinine test contradict the information submitted to the ACC.

Each time the user contacts the system, the respective Behavior Histories for system contact and cigarette smoking are updated accordingly. The respective FBR values are calculated with an Adherence Index (AI) approach (see above) based on the prior 6 weeks of behavior; urine cotinine values are used to validate or invalidate the FBR values corresponding to self-report cigarette smoking; static tables are used to determine whether reinforcement should be provided, and if so, the value thereof; the system determines whether a reward or penalty should be applied based on whether the behavior is desired or undesired, respectively. The system applies the reinforcement accordingly and issues a reinforcement report to the user.

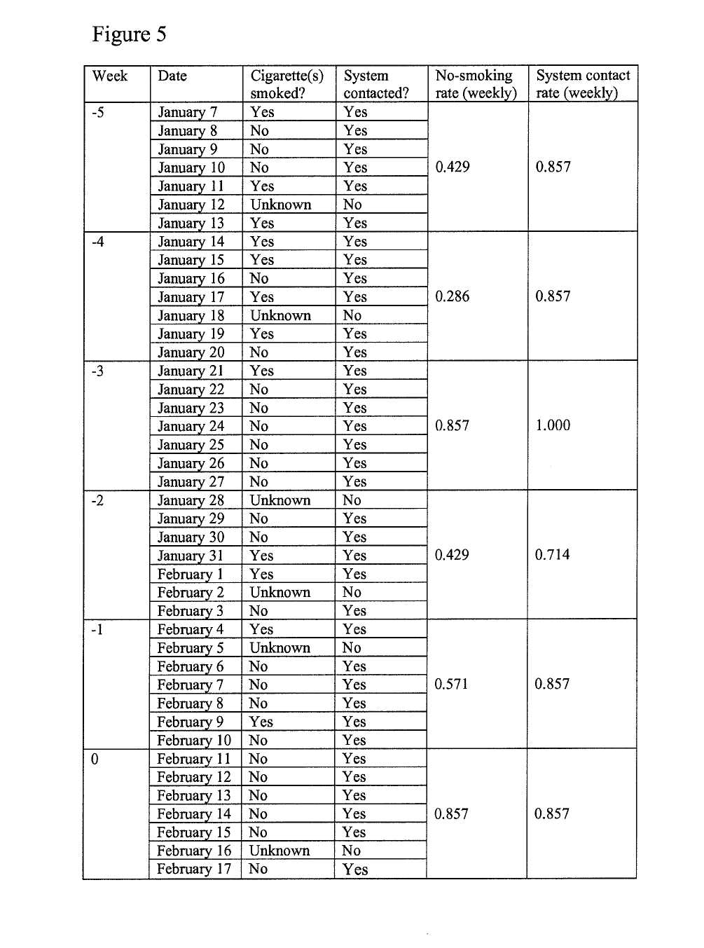

For this example, FIG. 5 summarizes the user's behavior history for the past 6 weeks (January 7 through February 17, inclusive). The FBR for cigarette smoking (an undesired behavior) will be calculated as a function of occasions when cigarette smoking did not occur. Conversely, the FBR for system contact (a desired behavior) will be calculated as a function of when system contact did occur. Using the AI method, the FBR for cigarette smoking is calculated as:

FBR=1/64+0.429/64+0.286/32+0.857/16+0.429/8+0.571/4+0.857/2≈0.70

Likewise, the FBR for system contact is calculated as:

FBR=1/64+0.857/64+0.857/32+1.000/16+0.714/8+0.857/4+0.857/2≈0.84

The above sums include the term 1/64 (1/2̂6) since there are six terms in the geometric series.

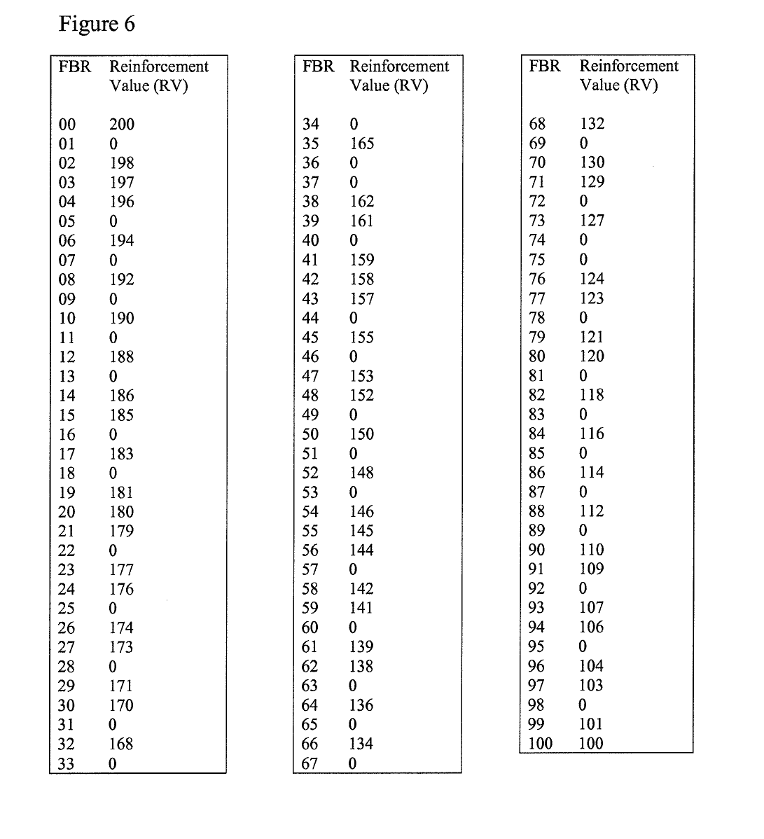

FIG. 6 shows an exemplary static table from which reinforcement can be calculated. The respective FBR values of 0.70 and 0.84 for cigarette smoking and system contact correspond to rows 70 and 84 on the static table, and Reinforcement Values of 130 and 116. A reward of 116 points is therefore applied for system contact, but a penalty in the form of delaying the reward of 130 points is applied for cigarette smoking. Since the penalty of 130 points exceeds the reward of 116 points, the entire reward will be delayed. In this example, the delay will remain in place until the patient's FBR for cigarette smoking improves to 0.90 or better. A reinforcement report is issued to the user by way of the ACC. The reinforcement report notifies the user that he or she has earned 116 points for system contact, but because of undesired cigarette smoking, these points will not be credited to the user's account until the cigarette smoking FBR, now at 70, improves to 90 or more.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A computer-implemented method for modifying the behavior of a user, the method performed by one or more processors and comprising:
storing in a memory a behavior history for the user;
calculating a Favorable Behavior Rate from the behavior history;
determining whether reinforcement should be provided;
if reinforcement is to be provided:
(1) determining a Reinforcement Value, wherein the value of the reinforcement is inversely correlated with the Favorable Behavior Rate;
(2) if the behavior is a desired behavior, applying the reinforcement as a reward;
(3) if the behavior is an undesired behavior, applying the reinforcement as a penalty; and
providing the user with a reinforcement report indicating whether a reward or penalty is to be applied and if so, the value thereof.

2. The method of claim 1, further comprising:
identifying the user and retrieving the user's behavior history.

3. The method of claim 2, further comprising:
recording a most recent behavior in the user's behavior history.

4. The method of claim 2, further comprising:
providing to the user a user identification code; and
obtaining the user identification code to identify the user.

5. The method of claim 1, whereby any two or more of the following steps are carried out in a single step:
determining whether reinforcement should be provided;
if reinforcement is to be provided:
(1) determining a Reinforcement Value, wherein the value of the reinforcement is inversely correlated with the Favorable Behavior Rate;
(2) if the behavior is a desired behavior, applying the reinforcement as a reward; and
(3) if the behavior is an undesired behavior, applying the reinforcement as a penalty.

6. The method of claim 1, whereby calculating the Favorable Behavior Rate for a desired behavior comprises:
determining a first number of times the user performed the desired behavior over a specified period of time; and
dividing the first number of times by a second number of times the user is expected to perform the desired behavior over the period of time.

7. The method of claim 1, whereby calculating the Favorable Behavior Rate for an undesired behavior comprises:
determining a first number of times the user's behavior was assessed and the user did not perform the undesired behavior over a specified period of time; and
dividing the first number of times by a second number of times the user's behavior was assessed over the period of time.

8. The method of claim 1, wherein a relationship between (i) a likelihood that a reward is provided or the value of the reward, and (ii) the user's Favorable Behavior Rate is described by a Spearman's rank correlation coefficient of less than zero.

9. The method of claim 1, wherein a relationship between (i) a likelihood that a reward is provided or the value of the reward, and (ii) the user's behavior adherence rate is described by a Spearman's rank correlation coefficient of −1.

10. The method of claim 1, wherein the penalty comprises delaying the applying and/or redemption of a reward.

11. A computer-implemented method for modifying the behavior of a user, whereby the method of claim 1 is carried out for a plurality of behaviors and the resulting reinforcement reports are combined into one reinforcement report.

12. The method of claim 2, further comprising:
maintaining a balance that is increased by the amount of any reward and decreased by the amount of any penalty or point redemption.

13. A system for obtaining a desired behavior from a user, comprising a contact center comprising:
a communications port,
a processor,
a memory, and
an electronic apparatus readable medium encoded with a program that when executed by the processor cause the processor to carry out the steps of the method of claim 1 or claim 11.

14. The system of claim 13, wherein the reward report further comprises, or is preceded or followed by, an informative or instructive message.

15. The system of claim 13, wherein the informative or instructive message is selected from among a plurality of messages depending on the Favorable Behavior Rate.
